(19) United States
(12) Patent Application Publication
(10) Pub. No.: US 2016/0098183 A1
(43) Pub. Date: Apr. 7, 2016

(54) METHOD FOR DISPLAYING AND MANAGING COMMUNICATION-TYPE INTERACTION SYMBOLS AND ASSOCIATED VIEWING DEVICE WITH A TOUCH SURFACE

(71) Applicant: THALES, Courbevoie (FR)

(72) Inventors: Stephanie LAFON, Merignac (FR); Alexiane Bailly, Marcheprime (FR); Quentin Virol, Le Bouscat (FR)

(21) Appl. No.: 14/874,361

(22) Filed: Oct. 2, 2015

(30) Foreign Application Priority Data
Oct. 3, 2014 (FR) 1402242

(51) Int. Cl. G06F 3/0484; G06F 3/01; G06F 3/0488

(52) U.S. Cl. CPC G06F 3/04847; G06F 3/0488; G06F 3/016

(57) ABSTRACT

The general field of the invention is that of methods for managing communications symbols in a viewing system including an associated viewing device comprising a touch surface and controlling, managing and displaying means. The interactor has three states that are a passive state, an active state and a state for setting one of the parameters of the communication. Said displaying and managing method comprises at least the following steps to apply a setting:

Step 1: on a first tactile stress, causing an interaction zone of oblong shape and an icon representative of the possible setting choices to appear;

Step 2: by holding and moving the tactile stress in the direction of the length of the interaction zone, selecting a given setting; and

Step by stopping the tactile stress, validating the new setting and causing the icon and the interaction zone to disappear.

The field of the invention is that of the presentation and management of what are referred to as tactile human-system interactions or HSIs in aircraft cockpits.

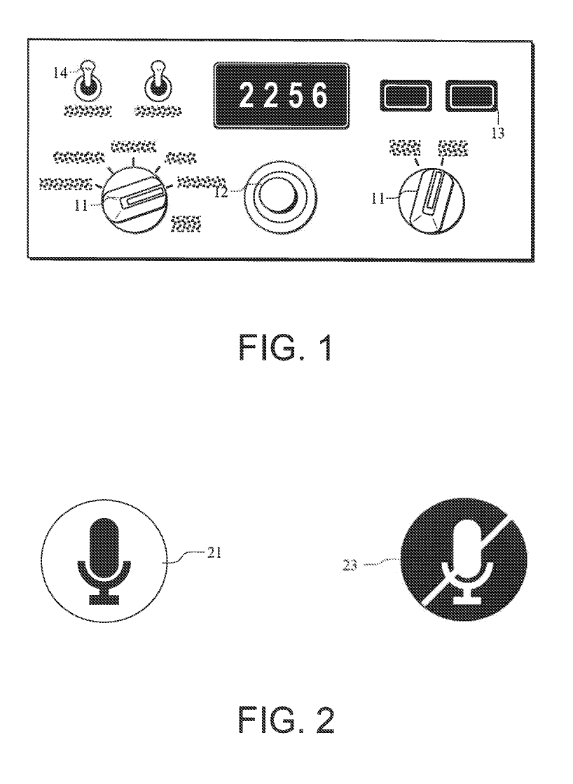

Currently, conventional interaction means in an aircraft cockpit are, in most applications, mechanical interactors. Thus, FIG. 1 shows a control station 10 according to the prior art comprising:
finite-state rotary control knobs 11 having a limited number of positions;
continuous rotary control knobs 12 allowing, for example, a parameter such as a volume level, to be set;
possibly mutually exclusive toggle buttons 13 optionally providing visual feedback; and
switches 14.

These conventional means are gradually being replaced by virtual interactors displayed on viewing devices comprising touch surfaces. This solution has many advantages in terms of cost, bulk, flexibility and reconfiguration. However, these tactile interactors must meet a certain number of recommendations specific to the world of aeronautics. In particular, they must:
provide a graphical representation similar to that of conventional buttons;
provide an informational display that is fit for purpose, readable and not very space-consuming;
provide intuitive and effective interaction modes and make blind setting of values possible;
allow critical tactile interactions to be fool-proofed; and
make effective interaction possible even under degraded meteorological conditions, i.e. in the case of turbulence.

Solutions have been proposed to address this problem. Mention may, in particular, be made of the publication US 2013/0249814 entitled “Adjustment mechanisms for virtual knobs on a touchscreen interface”, which describes the principle of a tactile interface intended to replace a physical rotary control knob in the following way. The “push/pull” function making it possible to pass from one mode to another is replaced by prolonged “clicks” on a graphical representation of the physical rotary control knob. On a single click by the user, the screen displays an interactive ring about the virtual rotary control knob. This interactive ring makes a circular interaction in a clockwise or anticlockwise direction possible, allowing a parameter associated with the rotary control knob to be incremented or decremented. The drawbacks of this solution are the following:
the graphical representation is sizeable and poorly suited to placement on the edge of a viewing screen;
a rotary movement is preserved in order for the interaction to remain similar to the existing interaction, However, the drawback of preserving this type of movement over a touch panel is that it is neither very ergonomic nor very effective;
the rotary control knob is not suitable for selecting between a finite number of states;
the interaction is poorly suited to use under turbulent conditions; and
the setting level is fixed.

The method according to the invention does not have these drawbacks, It makes it possible to replace the functions of a physical interactor, which are:
to modify a continuous value blind and to display the current value;
to select a state from a list and display the current state;
to pass from one state to another;
on/off function; and
to change state depending on external events.

The method according to the invention makes compact graphical representation possible. It may thus easily be positioned on a screen edge. This makes effective and fool-proof use possible whatever the meteorological conditions. Specifically, for the comfort of the operator or when there is turbulence, it is helpful to be able to grip onto the screen while interacting with the interactor.

More precisely, one subject of the invention is a method for displaying and managing interaction symbols in a communications system including at least one viewing device comprising a touch surface and means for displaying, managing and controlling said communications by means of at least one graphical interactor, characterized in that:
the interactor comprises at least three states that are a passive state characteristic of an absence of communication and represented by a first symbol, an active state characteristic of an established communication and represented by a second symbol and a setting state allowing one of the parameters of the communication to be set; and
said displaying and managing method comprises at least the following steps to apply a setting:
   Step 1: on a first tactile stress, causing an interaction zone of oblong shape to appear in the vicinity of the second symbol;
   Step 2: by holding and moving the tactile stress in the direction of the length of the interaction zone in said zone or outside said zone, selecting a given setting; and
   Step 3: by stopping the tactile stress, validating the new setting and causing the interaction zone to disappear.

Advantageously, the communications graphical interactor ensures a reception, emission or communications selection function.

Advantageously, a reception graphical interactor is coupled to an emission graphical switch, the two interactors being located facing each other on the viewing device.

Advantageously, when the interactor is an interactor dedicated to the reception of communications, when a communication is received, a graphical symbol dedicated to the reception appears around the interactor as long as the communication is not established.

Advantageously, when the setting state corresponds to continuous setting of the value of a parameter, the second symbol comprises a half-ring comprising an indicator, the angular position of the indicator being representative of said value.

Advantageously, when the interactor is located near the bottom or top of the screen of the viewing device, if the stress on the touch pan& is maintained without making other movements, at the end of a set lapse of time, the change of value of the parameter continues in the same sense as the last stress.

Advantageously, when the setting state corresponds to the choice of a particular option from a plurality of options, step 1 leads a plurality of indications to appear, each indication being representative of one option, movement of the stress causing the options to rotate and the selected option to change, said selected option being represented differently from the other non-selected options.

Advantageously, the touch surface comprises haptic means.

The invention also relates to a communications system including at least one associated viewing device comprising a touch surface and controlling, managing and displaying means, said communications system comprising electronic and digital means for implementing a method for managing graphical interactors allowing at least communications functions to be carried out, characterized in that:
the interactor comprises three states that are a passive state characteristic of an absence of communication and represented by a first symbol, an active state characteristic of an established communication and represented by a second symbol and a setting state allowing one of the parameters of the communication to be set; and
said displaying and managing method comprises at least the following steps to apply a setting:
   Step 1: on a first tactile stress, causing an interaction zone of oblong shape to appear and an icon representative of the possible setting choices to appear in the vicinity of the first or second symbol;
   Step 2: by holding and moving the tactile stress in the direction of the length of the interaction zone in said zone or outside said zone, selecting a given setting; and
   Step 3: by stopping the tactile stress, validating the new setting and causing the interaction zone to disappear.

Advantageously, some or ail of the graphical interactors are placed on the edge of the viewing screen.

The invention will be better understood, and other advantages will become apparent, on reading the following description, which is given by way of nonlimiting example, and from the appended figures in which:

FIG. 1, described above, shows a control station according to the prior art;

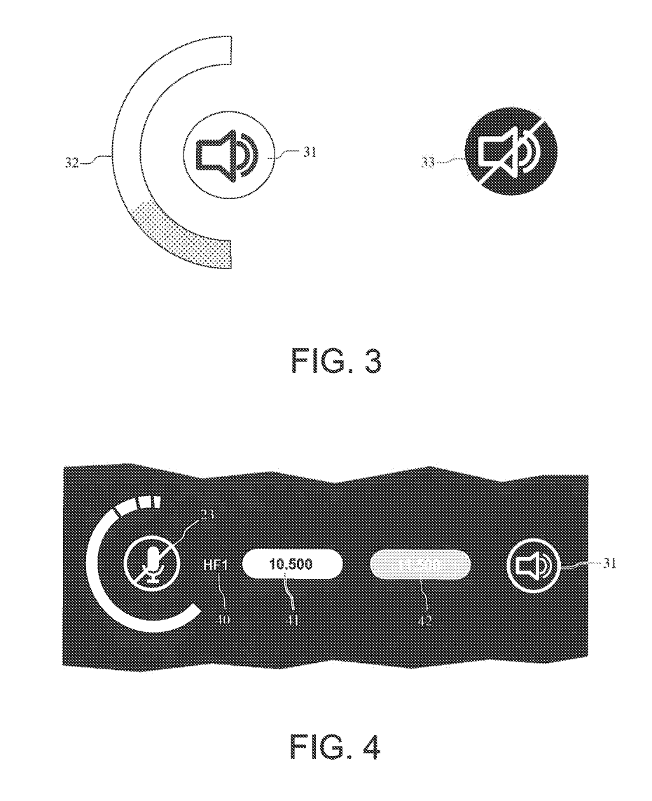

FIGS. 2 and 3 show two communications symbols in the passive and active states;

FIG. 4 shows conjointly an emission symbol and a reception symbol;

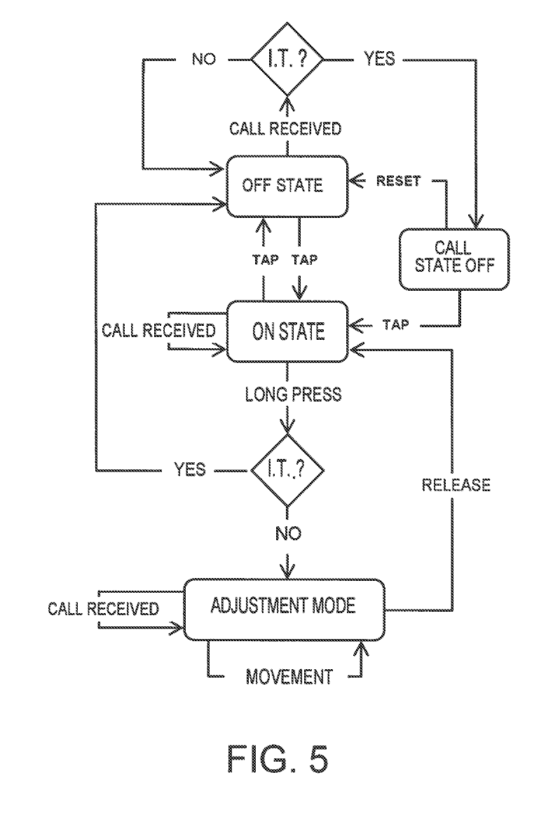

FIG. 5 shows the state diagram of the method according to the invention in the case of a communications function;

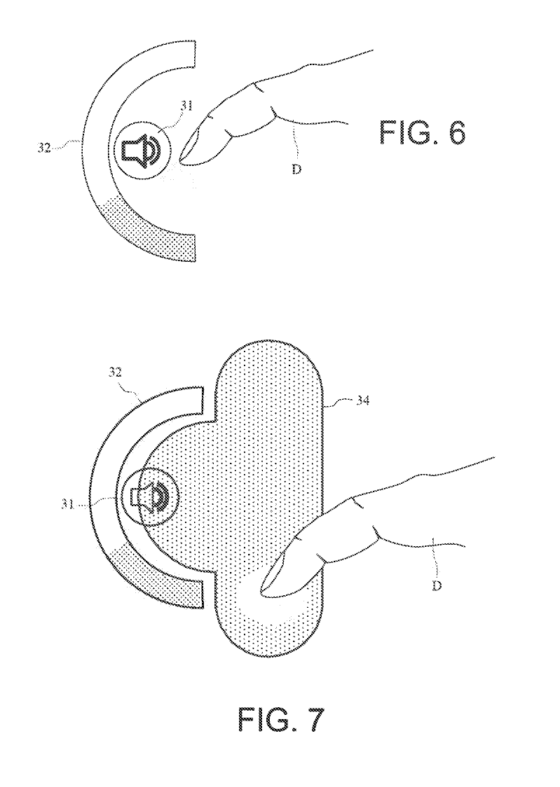

FIGS. 6, 7, 8 and 9 show the various steps of the method according to the invention in the case of setting of a telecommunications reception volume; and

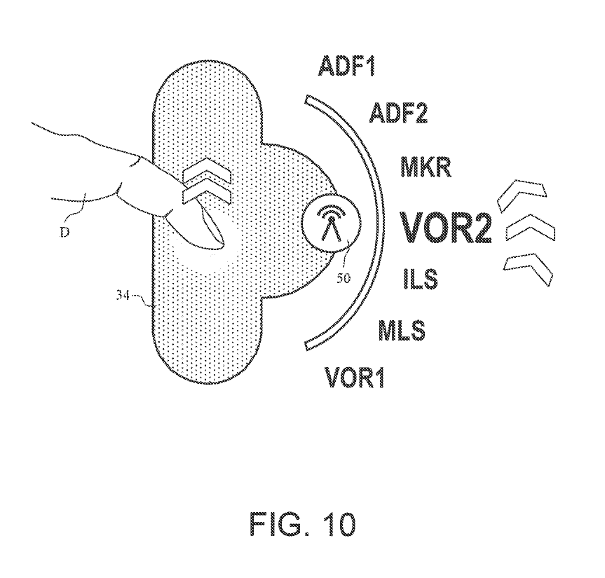

FIG. 10 shows one of the steps of the method in the case of a communications selection function.

The method according to the invention is implemented in a viewing system including at least one associated viewing device comprising a touch surface and controlling, managing and displaying means. These means are well known to those skilled in the art. The method according to the invention however requires the graphics generating software of the displaying means to be adapted so as to allow the various steps of the method to be carried out.

The method according to the invention is based, on the one hand, on the display of symbols representative of the functional state of a communicating means and, on the other hand, on state changes input via tactile stresses by the user. The interactor comprises three main states that are:
a passive or OFF state, characteristic of an absence of communication and represented by a first symbol;
an active or ON state, characteristic of an established communication and represented by a second symbol; and
an adjusting or setting state allowing one of the parameters of the communication to be set and represented by dedicated symbols.

In the context of aeronautical applications, a number of radio-frequency emission and reception channels are used. To each channel corresponds an emission path and a reception path. The various emission and reception paths are represented by icons or symbols of given type.

By way of first exemplary representation, the icons 21 and 23 in FIG. 2 represent the active and passive states of an interactor representing a vocal frequency emission mode. The active or ON emission mode to the left in FIG. 2 is symbolized by a black stylised microphone placed in a white circle. The passive or OFF state to the right in FIG. 2 is represented by a white microphone with a diagonal line running through it, in a black circle. Of course, these and the following symbols may comprise different shapes, colours and shadows. It is necessary and enough for the symbolic system to be sufficiently explicit of the active and passive states of the interactor.

An outside call modifies the state of a reception button in order to indicate that an outside interlocutor would like to communicate over a defined channel. A rotating half-circle may appear to represent this call state. It may be orange in colour. By pressing on the emission button corresponding to this channel, the user then passes into an emission mode corresponding to the ON state of the button and the call indication disappears. The corresponding reception button then automatically passes into the ON state.

By way of second exemplary representation, the icons 31 and 33 in FIG. 3 represent the active and passive states of an interactor representing a vocal frequency reception mode. The active or ON reception mode to the left in FIG. 4 is symbolized by a stylised loudspeaker placed in a white circle. It is surrounded by an arc 32 representing the sound volume. The bottom of the arc corresponds to the lowest volume and the top of the arc to the highest volume. The grey portion of the arc represents the volume level between these two extremes. The passive or OFF state to the right in FIG. 3 is represented by a loudspeaker with a diagonal line running through it, in a black circle. It will be noted that, on passing from the passive state to the active state, the last volume level used is automatically reactivated.

Generally, each reception graphical interactor is coupled to an emission graphical switch, the two interactors being located facing each other on the viewing device, as may be seen in FIG. 4. On a given line there feature, starting from the left: the emission interactor 23, which is shown cut off; the indication 40 of the emission channel, in the present case “HF1”; the emission and reception frequencies 41, 42 (the values indicated are “10.500” and “11.500”); and the reception interactor 31, which is shown open. Operation is as follows. If the transmission button is pressed following the reception of a CALL, symbolised by a white ring in FIG. 4 around the reception button, the system passes into a Transmission ON, Emission ON mode with a sufficiently high volume level.

By way of example, FIG. 5 shows the state diagram of the method according to the invention in the case of a communications function. In this diagram, the various states are represented by rectangles with rounded corners. They are denoted “OFF STATE”, “ON STATE”, “CALL STATE OFF” and “ADJUSTMENT MODE”. The transmission by the interactor is represented by a diamond framing the designation “I.T.?”, the various arrows of the diagram indicating the direction of the actions. The terms “TAP” designate a tactile stress of short duration, shorter than one second. The term “LONG PRESS” designates a tactile stress of longer duration, longer than one second. The term “MOVEMENT” means that the user moves his finger over the touch surface without releasing the pressure. The term “RELEASE” means that the stress ceases. The term “CALL RECEIVED” means that an outside third party is requesting communication.

FIGS. 6, 7, 8 and 9 show the various steps used to set a parameter in the case of a telecommunications reception function. In these various figures and in FIG. 10, the user is represented by his finger a The contact of the finger D on the touch surface is symbolised by a grey ellipse or circle. The movements of the finger D are symbolised by white double chevrons.

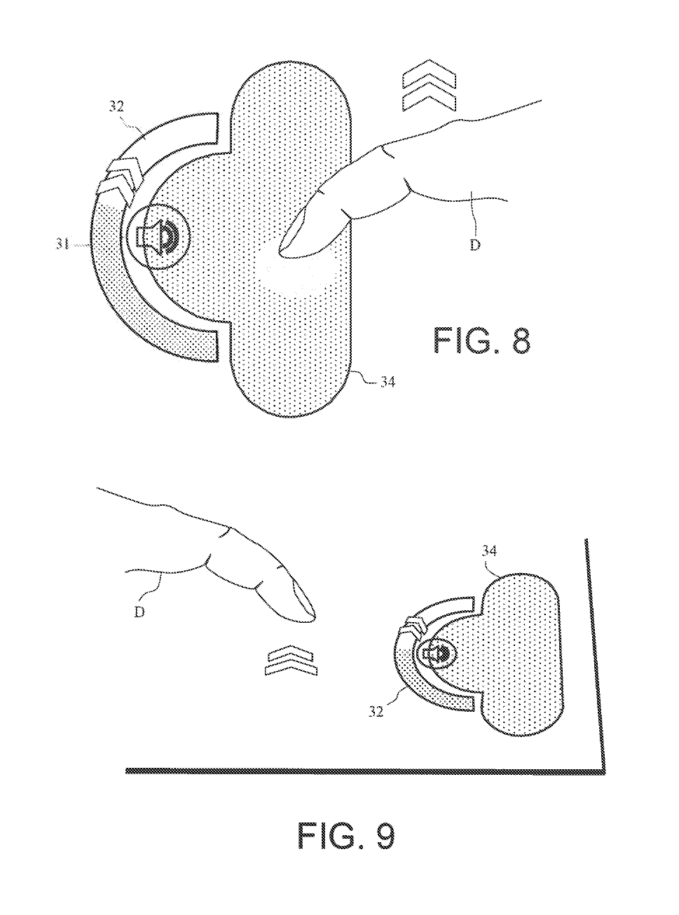

In FIG. 6, the receiver is in active mode. The icons of FIG. 3 are again shown. To set the sound volume, the user carries out the following operations, which are shown in FIGS. 7 and 8.

He applies a first tactile stress that corresponds to a long press. As may be seen in FIG. 7, an interaction zone 34 of oblong shape representative of the possible setting choices appears. This zone will also be referred to as the “interaction grip”. As may be seen in FIG. 8, by maintaining and moving the tactile stress in the direction of the length of the interaction zone, a given setting is selected. This setting is continuous. Haptic feedback may be added to indicate to the user that he has reached either the bottom limit stop or the top limit stop.

When the interaction zone is located near the bottom or top of the screen of the viewing device, if the stress on the touch panel is maintained without making other movements, at the end of a set lapse of time that however does not exceed a few seconds, the change of value continues in the same sense as the last stress. This method makes it possible for the user to reach extreme values without moving his finger. This solution is very practical insofar as the user is not constrained by the physical limits of the touch panel.

It is important to note that the stress may be applied either in the interaction zone or outside thereof as shown in FIG. 9 in which the finger of the user is clearly outside of the grip zone. Thus, even in the case of high turbulence, setting is possible. By stopping the tactile stress, the new setting is validated and the interaction zone disappears.

In the preceding example, the setting of the level is continuous. The method according to the invention may be applied to set discrete states as illustrated in FIG. 10. One option is selected from a list of options in the same way that a continuous value is set. When the user applies a first stress to a central symbol, a grip 34 appears surrounded by a plurality of indications representing the various possible options. The options are located on a circular arc and the movement of the finger from top to bottom makes the options rotate, like a carousel, until the desired option becomes the current state. To facilitate the choice, the preselected option appears differently to the other states. Removing the finger validates the selection. Haptic feedback may be added to better emphasize the passage from one option to another.

In FIG. 10, the central symbol represents an emitter 50 symbolised by a beacon. The various options are denoted “ADF1”, “ADF2”, “MKR”, “VOR2”, “ILS”, “MLS” and “VOR1”. The movements are symbolised in FIG. 9, as in the preceding figures, by a white double chevron. In this figure, the state “VOR2”, which is indicated by characters larger than the others, is the selected option. Here again, it is possible to indicate the selected option by another colour, by making it flash or by any other graphical means.

1. Method for displaying and managing interaction symbols in a communications system including at least one viewing device comprising a touch surface and means for displaying, managing and controlling said communications by means of at least one graphical interactor, wherein:
the interactor comprises at least three states that are a passive state characteristic of an absence of communication and represented by a first symbol, an active state characteristic of an established communication and represented by a second symbol and a setting state allowing one of the parameters of the communication to be set; and
said displaying and managing method comprises at least the following operations to apply a setting:
operation 1: on a first tactile stress, causing an interaction zone of oblong shape to appear in the vicinity of the second symbol;
operation 2: by holding and moving the tactile stress in the direction of the length of the interaction zone in said zone or outside said zone, selecting a given setting; and
operation 3: by stopping the tactile stress, validating the new setting and causing the interaction zone to disappear.

2. Method for displaying and managing interaction symbols according to claim 1, wherein the communications graphical interactor ensures a reception, emission or communications selection function.

3. Method for displaying and managing interaction symbols according to claim 2, wherein a reception graphical interactor is coupled to an emission graphical switch, the two interactors being located facing each other on the viewing device.

4. Method for displaying and managing interaction symbols according to claim 2, wherein, when the interactor is an interactor dedicated to the reception of communications, when a communication is received, a graphical symbol dedicated to the reception appears around the interactor as long as the communication is not established.

5. Method for displaying and managing interaction symbols according to claim 1, wherein, when the setting state corresponds to continuous setting of the value of a parameter, the second symbol comprises a half-ring comprising an indicator, the angular position of the indicator being representative of said value.

6. Method for displaying and managing interaction symbols according to claim 5, wherein, when the interactor is located near the bottom or top of the screen of the viewing device, if the stress on the touch panel is maintained without making other movements, at the end of a set lapse of time, the change of value of the parameter continues in the same sense as the last stress.

7. Method for displaying and managing interaction symbols according to claim 1, wherein, when the setting state corresponds to the choice of a particular option from a plurality of options, operation 1 leads a plurality of indications to appear, each indication being representative of one option, movement of the stress causing the options to rotate and the selected option to change, said selected option being represented differently from the other non-selected options.

8. Method for displaying and managing interaction symbols according to claim 1, wherein the touch surface comprises haptic means.

9. Communications system including at least one associated viewing device comprising a touch surface and controlling, managing and displaying means, said communications system comprising electronic and digital means for implementing a method for managing graphical interactors allowing at least communications functions to be carried out, wherein:
the interactor comprises three states that are a passive state characteristic of an absence of communication and represented by a first symbol, an active state characteristic of an established communication and represented by a second symbol and a setting state allowing one of the parameters of the communication to be set; and
said displaying and managing method comprises at least the following operations to apply a setting:
operation 1: on a first tactile stress, causing an interaction zone of oblong shape to appear and an icon representative of the possible setting chokes to appear in the vicinity of the first or second symbol;
operation 2: by holding and moving the tactile stress in the direction of the length of the interaction zone in said zone or outside said zone, selecting a given setting; and
operation 3: by stopping the tactile stress, validating the new setting and causing the interaction zone to disappear.

10. Viewing system according to claim 9, wherein some or all of the graphical interactors are placed on the edge of the viewing screen.
